(19) United States
(12) Patent Application Publication
(10) Pub. No.: US 2020/0160247 A1
(43) Pub. Date: May 21, 2020

(54) TO-DO MANAGEMENT APPARATUS, TO-DO MANAGEMENT METHOD, AND TO-DO MANAGEMENT PROGRAM

(71) Applicant: TOYOTA JIDOSHA KABUSHIKI KAISHA, Toyota-shi (JP)

(72) Inventors: Ryota OKUBI, Funabashi-shi (JP); Takeshi INOSHITA, Kashiwa-shi (JP); Ko KOGA, Tokyo (JP); Daisuke FURUKAWA, Chofu-shi (JP); Ryotaro FUJIWARA, Tokyo (JP); Toshiyuki HAGIYA, Shiki-shi (JP)

(73) Assignee: TOYOTA JIDOSHA KABUSHIKI KAISHA, Toyota-shi (JP)

(21) Appl. No.: 16/573,591

(22) Filed: Sep. 17, 2019

(30) Foreign Application Priority Data
Nov. 20, 2018 (JP) 2018-217668

(51) Int. Cl. G06Q 10/06; G07C 5/08

(52) U.S. Cl. CPC G06Q 10/06316; G07C 5/085

(57) ABSTRACT

A To-Do management apparatus includes a memory and a processor including hardware. The processor is configured to detect a time in which a driver of a vehicle is freed from driving operations of the vehicle, and provide, in the detected time, the driver with information for promoting accomplishment of a work that is entered in advance, that is not related to the driving operations of the vehicle, and that needs to be executed by the driver. Thus, it is possible to promote the accomplishment of the work that needs to be executed by the driver, at an appropriate timing and without interfering with the driver's driving operations.

### INCORPORATION BY REFERENCE

The disclosure of Japanese Patent Application No. 2018-217668 filed on Nov. 20, 2018 including the specification, drawings and abstract is incorporated herein by reference in its entirety.

### BACKGROUND

### 1. Technical Field

The disclosure relates to a To-Do management apparatus, a To-Do management method, and a To-Do management program that promote the accomplishment of a work (To-Do) that needs to be executed by a driver of a vehicle.

### 2. Description of Related Art

Japanese Unexamined Patent Application Publication No. 2016-062174 (JP 2016-062174 A) describes an information processing apparatus that estimates a user's free time period based on a history of the user's operations for posting information on the Internet, and provides a predefined notification to the user within the estimated free time period.

### SUMMARY

The information processing apparatus described in JP 2016-062174 A may be utilized to notify, within a user's free time period, the user of a work that needs be executed by the user. However, the information processing apparatus described in JP 2016-062174 A provides a notification within the user's estimated free time period even when the user is driving a vehicle, because the information processing apparatus estimates the user's free time period based on a history of the user's operation for positing information on the Internet. It is not appropriate to determine a period in which the user is driving the vehicle to be the driver's free time period and provide a notification in the period in which the user is driving the vehicle. In view of this, the information processing apparatus described in JP 2016-062174 A still has room for improvement.

The disclosure provides a To-Do management apparatus, a To-Do management method, and a To-Do management program that make it possible to promote the accomplishment of a work that needs to be executed by a driver, at an appropriate timing and without interfering with the driver's driving operations.

A To-Do management apparatus according to the disclosure includes a memory, and a processor including hardware. The processor is configured to detect a time in which a driver of a vehicle is freed from driving operations of the vehicle, and provide, in the detected time, the driver with information for promoting accomplishment of a work that is entered in advance, that is not related to the driving operations of the vehicle, and that needs to be executed by the driver.

In the To-Do management apparatus according to the disclosure set forth above, the processor may be configured to retrieve, from a plurality of works entered in advance, a work that is executable within the time, and provide the driver with information for promoting accomplishment of the retrieved work. Thus, it is possible to promote the accomplishment of the work that needs to be executed by the driver, without interfering with the driver's driving operations.

In the To-Do management apparatus according to the disclosure set forth above, the time may include at least one of a period during which the vehicle is stopped and a period during which autonomous driving of the vehicle is performed. Thus, it is possible to promote the accomplishment of the work that needs to be executed by the driver, without interfering with the driver's driving operations.

In the To-Do management apparatus according to the disclosure set forth above, the work may include at least one of making a restaurant reservation, returning a missed phone call, replying to an unreplied e-mail, and stock trading. Thus, it is possible to promote the accomplishment of the work that can be executed by the driver in a vehicle cabin.

A To-Do management method according to the disclosure is executed by a To-Do management apparatus. The To-Do management method includes: detecting a time in which a driver of a vehicle is freed from driving operations of the vehicle; and providing, in the detected time, the driver with information for promoting accomplishment of a work that is entered in advance, that is not related to the driving operations of the vehicle, and that needs to be executed by the driver.

A To-Do management program according to the disclosure is executed by a To-Do management apparatus. The To-Do management program includes: detecting a time in which a driver of a vehicle is freed from driving operations of the vehicle; and providing, in the detected time, the driver with information for promoting accomplishment of a work that is entered in advance, that is not related to the driving operations of the vehicle, and that needs to be executed by the driver.

With the To-Do management apparatus, the To-Do management method, and the To-Do management program according to the disclosure, a time in which a driver of a vehicle is freed from driving operations of the vehicle is detected; and, in the detected time, the driver is provided with information for promoting accomplishment of a work that is entered in advance, that is not related to the driving operations of the vehicle, and that needs to be executed by the driver. Thus, it is possible to promote the accomplishment of the work that needs to be executed by the driver, at an appropriate timing and without interfering with the driver's driving operations.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a block diagram illustrating the configuration of a To-Do management apparatus according to an embodiment; and

FIG. 2 is a flowchart illustrating the flow of a To-Do management process according to an embodiment.

### DETAILED DESCRIPTION OF EMBODIMENTS

Hereinafter, the configuration and operations of a To-Do management apparatus according to an embodiment will be described with reference to the accompanying drawings.

Configuration

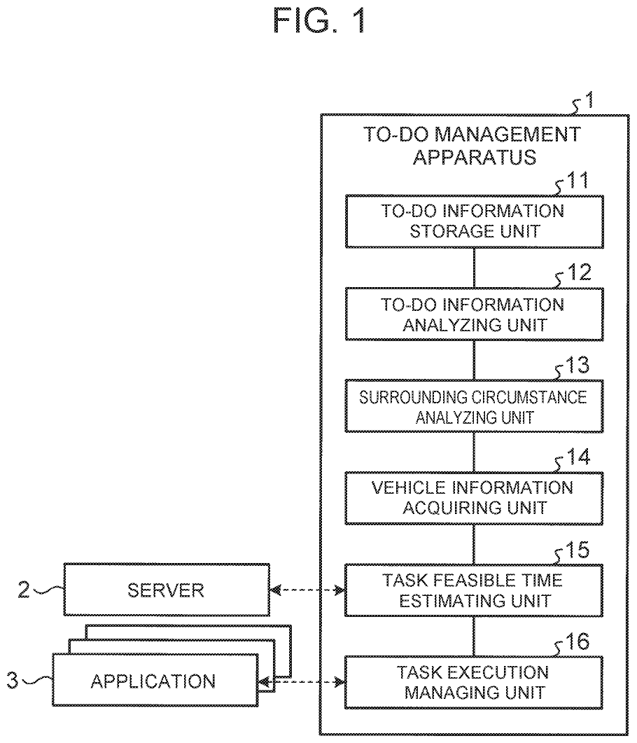

First, the configuration of the To-Do management apparatus according to the embodiment will be described with reference to FIG. 1.

FIG. 1 is a block diagram illustrating the configuration of the To-Do management apparatus according to the embodiment. As illustrated in FIG. 1, a To-Do management apparatus 1 according to the embodiment is an apparatus configured to promote the accomplishment of a work that is not related to driving operations of a vehicle and that needs to be executed by a driver (hereinafter, such a work will be referred to as “To-Do”). The To-Do management apparatus 1 is an information processing apparatus including a processor, such as a central processing unit (CPU), a digital signal processor (DSP) or a field programmable gate array (FPGA), and a memory, such as a random-access memory (RAM) or a read-only memory (ROM).

In the present embodiment, the To-Do management apparatus 1 includes a To-Do information storage unit 11, a To-Do information analyzing unit 12, a surrounding circumstance analyzing unit 13, a vehicle information acquiring unit 14, a task feasible time estimating unit 15, and a task execution managing unit 16, as main elements. The To-Do information storage unit 11 is composed of a memory included in the information processing apparatus. The To-Do information analyzing unit 12, the surrounding circumstance analyzing unit 13, the vehicle information acquiring unit 14, the task feasible time estimating unit 15, and the task execution managing unit 16 are each implemented through execution of a computer program by the processor included in the information processing apparatus. The functions of the To-Do information analyzing unit 12, the surrounding circumstance analyzing unit 13, the vehicle information acquiring unit 14, the task feasible time estimating unit 15, and the task execution managing unit 16 will be described later. These units may be provided in an in-vehicle apparatus of the vehicle, or may be provided in a server (center) 2 connected to the vehicle over a network. Alternatively, some of these units may be provided in the in-vehicle apparatus, and the remaining units may be provided in the server 2.

The computer program can be stored in a storage medium readable by a computer or the like. The computer program stored in the storage medium is read into and executed by the computer or the like, so that the computer or the like functions as the To-Do management apparatus 1. A storage medium readable by a computer or the like means a non-transitory storage medium that retains information, such as computer programs and data, by an electric, magnetic, optical, mechanical, or chemical action, and permits the information to be read by a computer or the like. Such storage media are classified into storage media removable from a computer or the like and storage media fixed in a computer or the like. Examples of storage media removable from a computer or the like include a flexible disk, magneto-optical disk, a compact disc-read only memory (CD-ROM), a compact disc-rewritable (CD-RW), a digital versatile disc (DVD), a Blu-ray disk, a digital audio tape (DAT), an 8-mm tape, and a memory card. Examples of storage media fixed in a computer or the like include a hard disk, and a ROM. Further, a solid state drive (SSD) can be utilized either as a storage medium removable from a computer or the like or as a storage medium fixed in a computer or the like.

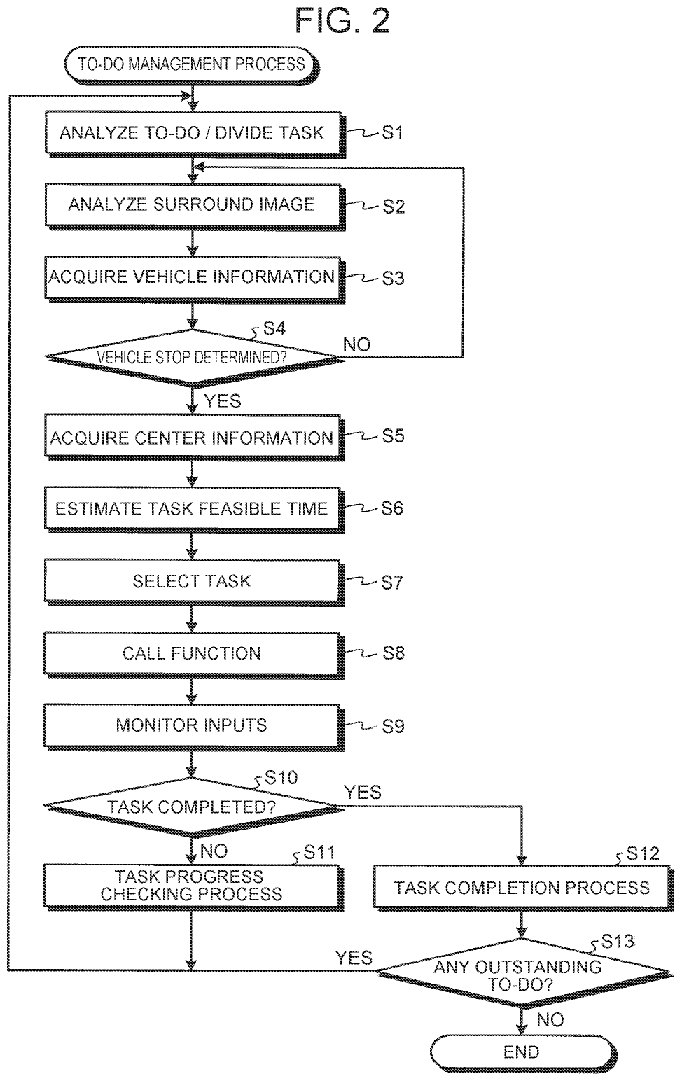

The To-Do management apparatus 1 having the foregoing configuration executes a To-Do management process described below, thereby providing the driver with information for promoting the accomplishment of a To-Do, at an appropriate timing and without interfering with the driver's driving operations. With reference to a flowchart illustrated in FIG. 2, the operations of the To-Do management apparatus 1 during execution of the To-Do management process will be described below.

To-Do Management Process

FIG. 2 is a flowchart illustrating the flow of the To-Do management process according to an embodiment. The flowchart illustrated in FIG. 2 is started at a timing when the driver of the vehicle enters information regarding To-Dos into the To-Do information storage unit 11 before starting driving the vehicle. The To-Do management process then proceeds to processing at step S1.

Examples of the To-Dos include works that can be executed in a vehicle cabin, such as making a restaurant reservation, returning a missed phone call, replying to an unreplied e-mail, and stock trading. The driver can enter the information regarding the To-Dos into the To-Do information storage unit 11 by operating an input device, such as a keyboard, a touch panel, or a microphone, connected to the To-Do management apparatus 1, by forwarding information entered into a terminal device, such as a smartphone, a mobile phone or a tablet terminal, or information stored therein to the To-Do management apparatus 1, or by linking a To-Do management application in an information processing apparatus, such as a personal computer, to the To-Do management apparatus 1. When entering information regarding a To-Do into the To-Do information storage unit 11, the driver may also enter an expected handling time for the To-Do into the To-Do information storage unit 11.

In the processing at step S1, the To-Do information analyzing unit 12 analyzes the information regarding To-Dos stored in the To-Do information storage unit 11 and assigns, to the information regarding each To-Do, information regarding a time required to accomplish the To-Do (execution possible time) as attribute information. When the expected handling time for a To-Do is entered into the To-Do information storage unit 11 in advance, the To-Do information analyzing unit 12 assigns, to the information regarding the To-Do, the expected handling time as attribute information. More specifically, when the content of a To-Do stored in the To-Do information storage unit 11 is replying to an unreplied e-mail, the To-Do information analyzing unit 12 assigns, to the information regarding the To-Do, the execution possible time for the To-Do as attribute information. When the content of a To-Do is making a restaurant reservation, the To-Do information analyzing unit 12 divides the To-Do into multiple tasks by generating tasks to ask the driver for unentered pieces of information among multiple pieces of information that are necessary for reserving the restaurant, such as the location, the reservation time, the number of persons, and the restaurant's name (slot filling format). For example, when the location and the restaurant's name have not been entered, the To-Do information analyzing unit 12 generates a task to ask the driver for the location and a task to ask the driver for the restaurant's name. Then, the To-Do information analyzing unit 12 assigns, to the information regarding the generated tasks, the execution possible times as attribute information. When all of the multiple pieces of information necessary for reserving the restaurant have been entered, the To-Do information analyzing unit 12 assigns, to the information regarding the To-Do, the execution possible time for reserving the restaurant as attribute information. This processing by the To-Do information analyzing unit 12 can be implemented by setting rules (e.g., execution possible time and necessary information) for each To-Do content beforehand and causing the To-Do information analyzing unit 12 to operate according to the rules. The processing at step S1 is thereby completed and the To-Do management process proceeds to processing at step S2.

In the processing at step S2, the surrounding circumstance analyzing unit 13 causes an image-capturing device provided in the vehicle to capture an image of an area around the vehicle being driven by the driver (such an image will be referred to as “surround image”), and then detects data indicating the surrounding circumstances of the vehicle being driven by the driver, such as a distance to a preceding vehicle (inter-vehicle distance), a stop lamp of the preceding vehicle, a line of cars ahead of the vehicle (congestion condition), and colors of traffic lights ahead of the vehicle, based on the captured surround mage. The processing at step S2 is thereby completed and the To-Do management process proceeds to processing at step S3.

In the processing at step S3, the vehicle information acquiring unit 14 acquires vehicle information, such as an acceleration and a speed of the vehicle being driven by the driver. The processing at step S3 is thereby completed and the To-Do management process proceeds to processing at step S4.

In the processing at step S4, the task feasible time estimating unit 15 determines whether or not the vehicle is stopped or is predicted to stop based on the data indicating the surrounding circumstances of the vehicle detected by the surrounding circumstance analyzing unit 13 and the vehicle information acquired by the vehicle information acquiring unit 14. When the task feasible time estimating unit 15 determines that the vehicle is stopped or is predicted to stop (step S4: Yes), the task feasible time estimating unit 15 determines that the driver has been freed from the driving operations of the vehicle or is to be freed from the driving operations of the vehicle, and then causes the To-Do management process to proceed to processing at step S5. On the other hand, when the task feasible time estimating unit 15 determines that the vehicle is neither stopped nor predicted to stop (step S4: No), the task feasible time estimating unit 15 determines that the driver has not been freed from the driving operations of the vehicle and is not to be freed from the driving operations of the vehicle, and then returns the To-Do management process to the processing at step S2. Examples of cases where the vehicle is predicted to stop include a case where a traffic light ahead of the vehicle is red, a case where a traffic light ahead of the vehicle is predicted to turn red based on traffic light cycle information, and a case where the inter-vehicle distance has fallen below a predefined distance. Other examples of a time in which the driver is freed from the driving operations of the vehicle include a time during which an autonomous driving process is executed.

In the processing at step S5, the task feasible time estimating unit 15 acquires congestion information and traffic light cycle information (center information) for a current location of the vehicle from the server 2, and then predicts a remaining vehicle stopped duration based on the acquired center information. For example, when it is determined that the vehicle is stopped at a red traffic light, the task feasible time estimating unit 15 predicts, as the remaining vehicle stopped duration, a remaining time of the red traffic light calculated based on the traffic light cycle information. The traffic light cycle information is information including a length of time during which a traffic light is red in each time period, and can be generated by a statistical technique based on images of traffic lights acquired by the surrounding circumstance analyzing unit 13 or by acquisition from traffic lights compatible with dedicated short range Communications (DSRC) or intelligent transport systems (ITS). These pieces of information may also be acquired through road-to-vehicle communication based on vehicle-to-X (V-to-X) technologies. The processing at step S5 is thereby completed and the To-Do management process proceeds to processing at step S6.

In the processing at step S6, the task feasible time estimating unit 15 estimates, as a task feasible time, a time during which a To-Do and/or a task generated from a To-Do can be executed, based on the remaining vehicle stopped duration predicted in the processing at step S5. For example, when the remaining vehicle stopped duration associated with a red traffic light is one minute, the task feasible time estimating unit 15 sets 45 seconds, which is shorter than the vehicle's remaining stopped duration of one minute, as the task feasible time such that driving operations of the vehicle are not hindered. When the vehicle is parked in a parking place, the task feasible time estimating unit 15 can estimate the task feasible time based on an idling state of the vehicle. When autonomous driving of the vehicle is being performed, the task feasible time estimating unit 15 can estimate the task feasible time based on the inter-vehicle distance and the vehicle speed relative to the preceding vehicle. The processing at step S6 is thereby completed and the To-Do management process proceeds to processing at step S7.

In the processing at step S7, the task execution managing unit 16 retrieves, from the To-Do information storage unit 11, a To-Do and/or a task generated from a To-Do to which an execution possible time or an expected handling time shorter than the task feasible time estimated in the processing at step S6 is assigned as attribute information, and then selects the retrieved To-Do and/or task generated from a To-Do as a task to be processed (hereinafter, referred to as “target task”). When multiple To-Dos and/or tasks generated from To-Dos are retrieved, the task execution managing unit 16 may select a target task from the multiple To-Dos and/or tasks generated from To-Dos, according to predefined priorities. In this case, the priorities may be dynamically changed. For example, the priority of a halfway executed target task may be increased. When no appropriate task is retrieved, the task execution managing unit 16 may return the To-Do management process to the processing at step S2. The processing at step S7 is thereby completed and the To-Do management process proceeds to processing at step S8.

In the processing at step S8, the task execution managing unit 16 calls an application (function) 3 corresponding to the target task selected according to predefined rules in the processing at step S7. The application 3 that has been called provides the driver with information for promoting the execution of the target task by presenting an interface, such as a human-machine interface (HMI). For example, when the To-Do is making a restaurant reservation, the application 3 may display a reservation website for a restaurant to be reserved. The processing at step S8 is thereby completed and the To-Do management process proceeds to processing at step S9.

In the processing at step S9, the task execution managing unit 16 monitors input operations on the interface presented to the driver by the application 3 called in the processing at step S8. The processing at step S9 is thereby completed and the To-Do management process proceeds to processing at step S10.

In the processing at step S10, the task execution managing unit 16 determines whether the execution of the target task is completed based on a return value (a task completion flag) of a call to an application programming interface (API) of the application 3 called in the processing at step S8. Specifically, when a value of the task completion flag is a predetermined value, the task execution managing unit 16 determines that the execution of the target task is completed. When the task execution managing unit 16 determines that the execution of the target task is completed (step S10: Yes), the task execution managing unit 16 causes the To-Do management process to proceed to the processing at step S12. On the other hand, when the task execution managing unit 16 determines that the execution of the target task is not completed (step S10: No), the task execution managing unit 16 causes the To-Do management process to proceed to processing at step S11.

In the processing at step S11, the task execution managing unit 16 saves a result of halfway execution of the target task in the To-Do information storage unit 11 such that the halfway executed target task is preferentially selected when the processing at step S7 is executed next time. In this case, the task execution managing unit 16 may notify the driver about how far the target task is executed in the last processing. The task may be suspended and saved as a halfway task, at a timing when an operation on an accelerator pedal or a shift lever is detected in a case where the vehicle has been parked in a parking place, or at a timing when the driving mode is switched from the autonomous driving mode to the manual driving mode in a case where autonomous driving of the vehicle has been performed. The processing at step S11 is thereby completed and the To-Do management process returns to processing at step S1.

In the processing at step S12, the task execution managing unit 16 deletes information regarding the target task that has been accomplished from the To-Do information storage unit 11. The processing at step S12 is thereby completed and the To-Do management process proceeds to processing at step S13.

In the processing at step S13, the task execution managing unit 16 determines whether any information regarding a To-Do has been entered in the To-Do information storage unit 11. When the task execution managing unit 16 determines that information regarding a To-Do has been entered in the To-Do information storage unit 11 (step S13: Yes), the task execution managing unit 16 determines that there is an unaccomplished (outstanding) To-Do and returns the To-Do management process to the processing at step S1. On the other hand, when the task execution managing unit 16 determines that no information regarding any To-Do has been entered in the To-Do information storage unit 11 (step S13: No), the task execution managing unit 16 determines that there is no unaccomplished To-Do and ends a series of To-Do management processing.

As is apparent from the foregoing description, the To-Do management apparatus 1 according to the foregoing embodiment detects a time in which a driver of a vehicle is freed from driving operations of the vehicle and provides, in the detected time, the driver with information for promoting the accomplishment of a To-Do. Thus, the To-Do management apparatus 1 can promote the accomplishment of the To-Do, at an appropriate timing and without interfering with the driver's driving operations.

While the example embodiments made by the inventors have been described, further advantageous effects and/or modified examples thereof could be easily derived by a person skilled in the art. A broader aspect is not limited to specific details and representative embodiments illustrated and described above. Therefore, various modifications may be made to the foregoing embodiments without departing from the technical scopes of the disclosure defined by the appended claims and equivalents thereof.

What is claimed is:

1. A To-Do management apparatus comprising:
a memory; and
a processor including hardware,
wherein the processor is configured to
detect a time in which a driver of a vehicle is freed from driving operations of the vehicle, and
provide, in the detected time, the driver with information for promoting accomplishment of a work that is entered in advance, that is not related to the driving operations of the vehicle, and that needs to be executed by the driver.

2. The To-Do management apparatus according to claim 1, wherein the processor is configured to:
retrieve, from a plurality of works entered in advance, a work that is executable within the time; and
provide the driver with information for promoting accomplishment of the retrieved work.

3. The To-Do management apparatus according to claim 1, wherein the time includes at least one of a period during which the vehicle is stopped and a period during which autonomous driving of the vehicle is performed.

4. The To-Do management apparatus according to claim 1, wherein the work includes at least one of making a restaurant reservation, returning a missed phone call, replying to an unreplied e-mail, and stock trading.

5. A To-Do management method that is executed by a To-Do management apparatus, the To-Do management method comprising:
detecting a time in which a driver of a vehicle is freed from driving operations of the vehicle; and
providing, in the detected time, the driver with information for promoting accomplishment of a work that is entered in advance, that is not related to the driving operations of the vehicle, and that needs to be executed by the driver.

6. A To-Do management program that is executed by a To-Do management apparatus, the To-Do management program comprising:
detecting a time in which a driver of a vehicle is freed from driving operations of the vehicle; and
providing, in the detected time, the driver with information for promoting accomplishment of a work that is entered in advance, that is not related to the driving operations of the vehicle, and that needs to be executed by the driver.
